(19) United States
(12) Patent Application Publication
(10) Pub. No.: US 2010/0195492 A1
(43) Pub. Date: Aug. 5, 2010

(54) Controlling Traffic in a Packet Switched Communications Network

(76) Inventors: Janos Harmatos, Budapest (HU); Attila Mihaly, God (HU)

Correspondence Address: COATS & BENNETT, PLLC, 1400 Crescent Green, Suite 300, Cary, NC, 27518, US

(21) Appl. No.: 12/670,049

(22) PCT Filed: Jul. 23, 2007
(86) PCT No.: PCT/EP07/57568

§ 371 Date: Feb. 25, 2010

(51) Int. Cl. H04L 12/56

(52) U.S. Cl. 370/230

(57) ABSTRACT

The present invention relates to a packet switched communications network especially to an Ethernet network in which User Network Interfaces (UNI) are standardized between client network (202) and core network (203) with a number of UNI service attributes. In one aspect of the invention a method is used in current packet switched nodes implementing a policer function. The task of the function is to decide whether packets with high drop preference need to be dropped or not due to resource shortage on the given interface. All outgoing packets at a given port will undergo this policer (401) irrespective of the source, destination, identification codes or traffic class. Policer (401) drops packets with high drop preference in one traffic class before a packet of low drop preference is dropped in any other traffic class, and drops packets with high drop preference before a packet of low drop preference is dropped in the same queue. In the course of dropping packets, policer (401) prevents the reordering of packets with low drop preference and packets with high drop preference within the same flow.

### BACKGROUND OF THE INVENTION

1. Technical Field of the Invention

The present invention relates to a packet switched communications network. In particular, and not by way of limitation, the present invention is directed to a method, to a network node and to a network for controlling user traffic according to a policy defined to the network.

2. Description of Related Art

There is a growing need among individuals and enterprises for access to a commonly available, cost effective network that provides speedy, reliable services. There is high demand for a high-speed communications network with enough bandwidth to enable complex two-way communications. Such an application is possible today if, for example, access is available to a university or a corporation with sufficient finances to build this type of network. But for the average home computer user or small business, access to high speed data networks is expensive or simply impossible. Telephone companies are therefore eager to deliver broadband services to meet this current explosion in demand.

A communication system may provide the user, or more precisely, user equipment or terminal, with connection-oriented communication services and/or connectionless communication services. An example of the first type is a circuit switched connection where a circuit is set-up with call set-up and admission control. An example of a connectionless communication service is a so called packet switched service which is typically used for communicating packet data.

Ethernet has been developed as a packet switched network technology for local area networks (LANs) of data communication, driven by its relatively low cost in comparison with other competing technologies. Although technologies such as ATM (Asynchronous Transfer Mode) have been proposed as the network technology for support of multimedia to desktop, the large installed base of 10 Mbps Ethernet networks, the rapid proliferation of 10/100 Mbps Ethernet (Fast Ethernet) and the emerging Gigabit Ethernet technologies suggest that Ethernet will be the underlying technology for supporting real-time, continuous media services to the desktop. In packet switched networks with many senders transmitting at any time, it is impossible to predict traffic levels. Some parts of the network may become more congested than others. The solution is to place queues throughout the network to absorb bursts from one or more senders.

In existing Ethernet networks IEEE standardizes the process of forwarding an Ethernet frame together with service class based queuing, queue management complete with handling drop precedence and frame transmission selection.

Regarding queuing management IEEE standards enable the implementation of any kind of queuing mechanism from strict priority queuing to Weighted Fair Queuing (WFQ). Regarding drop eligibility the IEEE 802.1ad standards defines: The drop eligible parameter provides guidance to the recipient of the service indication or of an indication corresponding to the service request, and takes the values ‘True’ or ‘False’ as it is described in IEEE P802.1ad/D6.0, Virtual Bridged Local Area Networks–Amendment 4: Provider Bridges. If drop eligible is ‘True’ then the parameters of the indication should be discarded in preference to others with drop eligible ‘False’ that result in frames queued with the same traffic class. Traffic differentiation or classification is the first step in providing Quality of Service (QoS) differentiated services.

The drop eligibility information is carried in the Ethernet 802.1ad frame as a Drop Eligible (DE) bit. In case of DE=1 the frames can be discarded if needed.

On the other hand, it is also known that Metro Ethernet Forum (MEF) standardizes the User Network Interface (UNI) between the client (home) network and the Metro Core network with a number of UNI service attributes including the following bandwidth profile parameters as it is described in MEF 10 Ethernet Service Attributes phase 2, (draft 4) 13 Jan. 2006:
Committed Information Rate (CIR) expressed as bits per second. CIR MUST be ≧0.
Committed Burst Size (CBS) expressed as bytes. When CIR >0, CBS MUST be greater than or equal to the largest Maximum Transmission Unit size among all of the Ethernet Virtual Connections (EVCs) that the Bandwidth Profile applies to.
Excess Information Rate (EIR) expressed as bits per second. EIR MUST be ≧0
Excess Burst Size (EBS) expressed as bytes. When EIR >0, EBS MUST be greater than or equal to the largest Maximum Transmission Unit size among all of the EVCs that the Bandwidth Profile applies to.
MEF also proposes a method for disposition of the frames on the UNI. The table of disposition is show on FIG. 1, and can be summarized as follows:
The frames, which are within the CIR and CBS limits are forwarded and served according to the QoS parameters (delay, jitter, loss ratio, etc.) specified in the Service Level Agreement (SLA) (green frames).
The frames, which are within the EIR and EBS limits may be forwarded, however these frames are marked and they have no QoS guarantees (yellow frames).
The frames, which are out of the EIR and EBS limits, are discarded. (red frames).

Coloring the frames according to the traffic profiles takes place at the edge devices. Obviously, the information about re-colored traffic should be conveyed through the operator network in order that the operator devices have the necessary knowledge about which frames to discard in case of resource shortage.

As it can be seen on FIG. 2, in the existing network model there is a MEF UNI 201 between the client network 202 and the Metro Ethernet Network 203. In a special implementation the Metro Ethernet network 203 consists of IEEE 802.1ad compatible network nodes 204 (only one of them is furnished with reference number 204 in the figure). These nodes are able to distinguish and handle DE bit.

The practical way for mapping the MEF disposition to IEEE frames in a Metro Ethernet network based on IEEE 802.1ad compatible switches would be that the green frames should be left with DE=0, while the yellow frames should be marked with DE=1. All other ways of mapping the re-coloring information would impact IEEE standardization. There are, however, some problems arising from the different interpretation of yellow and DE=1 frames by MEF and IEEE, respectively.

According to MEF specifications, yellow frames do not have any QoS guarantees. The natural consequence of this statement is that in case of congestion, DE=1 frames should be dropped before any DE=0 frame is dropped in any other traffic class, maybe except best effort (BE) traffic class.

It is clearly seen, that this requirement cannot be fulfilled by using some dynamic queue management methods, like Random Early Detect—In and Out (RIO) as it is described by David D. Clark, Fellow, IEEE, and Wenjia Fang: “Explicit Allocation of Best-Effort Packet Delivery Service” in IEEE/ACM TRANSACTIONS ON NETWORKING, VOL. 6, NO. 4, AUG. 1998.

It should be noted that the IEEE definition for handling the frames with DE=1 suggests the utilization of dynamic queue management: “DE=1 frames need to be dropped before any DE=0 frame is dropped in the same queue”.

A simple example shown in FIG. 3 helps to understand the problem. Let's assume two queues Q1, Q2 with the same weight w1 and w2 carrying about the half of the link rate C each at the output of a scheduler 301. In the first queue Q1 there are some frames with DE=1, and the second queue Q2 is overflowing, but it contains only DE=0 frames. According to the IEEE queue management, in this case the DE=1 frames will be forwarded from the first queue Q1, while some DE=0 frames are dropped from the second queue Q2. However, this process is not accordant to the MEF definition formulating the intention of not having any QoS guarantees for the DE=1 frames, as in this case DE=1 frames will have priority over the DE=0 frames in the second queue.

The problem described above cannot be overcome by proper network provisioning. Even with properly provisioned networks where edge policing prohibits unexpected traffic fluctuations such cases might occur due to special network situations e.g., transport failures.

Consequently, a control is needed, which provide a service, based on drop eligible concept in a packet switched communication network and especially for Ethernet networks in order to reconcile the MEF concept of handling re-colored frames with IEEE specifications of handling DE=1 frames, i.e., enables that the yellow frames with DE=1 will be served by IEEE switches according to the IEEE standardized DE bit definition but the QoS-handling of DE=1 frames will be according to the MEF requirements (best effort).

### SUMMARY OF THE INVENTION

Accordingly, it is the object of the invention to improve network performance especially to provide a method for controlling traffic in a packet switched communications network to provide a service, based on drop eligibility concept and especially for reconciling MEF concept with IEEE specification in an Ethernet network.

In another aspect, the present invention is directed to a network node with a policer in the outgoing interface of the network node.

It is particularly an object of the invention to set up a packet switched network put together of network nodes comprising policer.

The invention is based on the recognition that a suitable policy of dropping packets used in current packet switched nodes can implement a policer function. The task of the function is to decide whether packets with high drop preference need to be dropped or not due to resource shortage on the given interface.

All outgoing packets at a given port will undergo this policer irrespective of the source, destination, identification codes or traffic class.

Policer drops packets with high drop preference in one traffic class before a packet of low drop preference is dropped in any other traffic class, and drops packets with high drop preference before a packet of low drop preference is dropped in the same queue. In the course of dropping packets, policer prevents the reordering of packets with low drop preference and packets with high drop preference within the same flow.

In a preferred embodiment policing of packets takes place based on a combined decision logic considering the available tokens from an attached standard token bucket and the drop eligible bit of the packet. The packets with low drop preference are forwarded onto the output queues in any case, but they consume tokens from the token bucket, if available. The packets with high drop preference are however forwarded only if there are available tokens in the token bucket, otherwise they are dropped.

The most important advantage of the invention is that an optimal utilization of outgoing links can be provided in a network node of a packet switched network.

The special advantage of the invention is that the MEF requirement on frame dropping can be fulfilled on one hand, and on other hand the output queues guarantee the proper IEEE standardized differentiated handling of frames.

### BRIEF DESCRIPTION OF THE DRAWINGS

In the following, the essential features of the invention will be described in detail with reference to the figures of the attached drawing for an Ethernet network, in which packets are called as frames the drop preference of which are designated by drop eligible bits DE=0 and DE=1 for low and high drop preference, respectively.

FIG. 1 shows the table of MEF prescription for disposition of the different frames; FIG. 2 shows a packet switched communications network realized on Ethernet infrastructure with 802.1ad or above switches;

FIG. 3 is an example traffic scenario on classical queuing system causing loss of DE=0 frames while transmitting DE=1 frames from a different queue;

FIG. 4 illustrates the queuing architecture with the policer before queuing at the outgoing interface of the network node;

FIG. 5 is a flow chart illustrating the drop decision logic of the policer;

FIG. 6 shows a possible embodiment of the policer;

FIG. 7 illustrates the relevant part of an Ethernet frame header according to IEEE 802.1ad switch;

FIG. 8 is a flow chart illustrating the drop decision logic of the policer taking into account of BE frames.

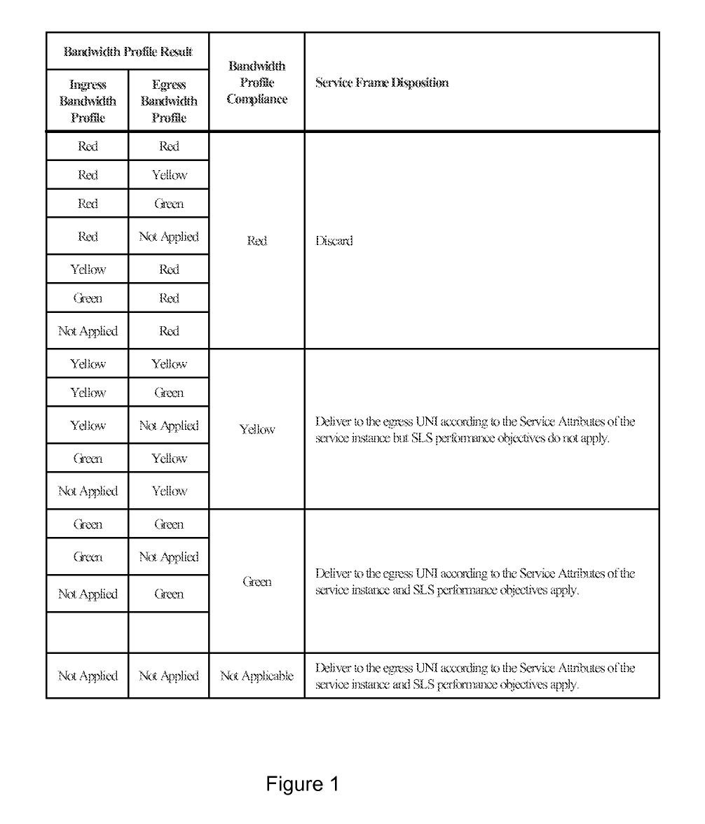

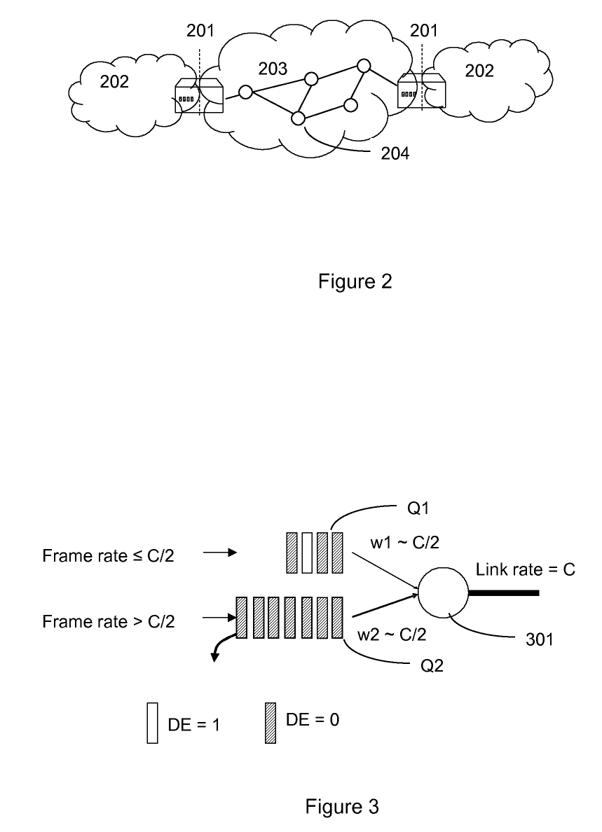

### DETAILED DESCRIPTION OF THE INVENTION

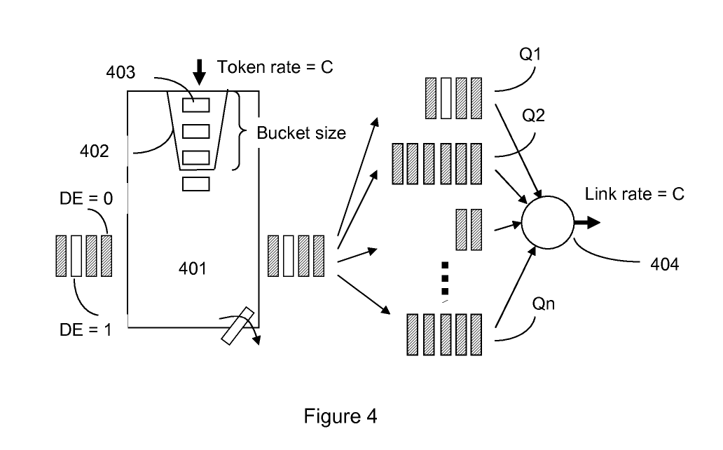

Before referring to FIG. 4, which sketches the basic functionality of the invention implemented in an Ethernet network and which is shortly explained below, the object of the invention, is listed in the following requirements that a combined policing/queuing concept should fulfill:
a) DE=1 frames should be dropped before any DE=0 frame is dropped in any other traffic class (exception may be BE). This requirement translates from the MEF specification.
b) DE=1 frames needs to be dropped before any DE=0 frame is dropped in the same queue. This requirement is coming from the IEEE definition of handling the frames with DE=1.
c) Reordering of DE=0 and DE=1 frames within the same flow is not permitted. This is imposed by applications that might suffer severe degradation if they experience packet reordering within the same flow. This requirement is guaranteed by 802.1ad switches according to specifications. It should be noted that the requirement implies mapping DE=1 and DE=0 frames of the same traffic class to the same queue, i.e., excludes solutions when DE=1 frames would be mapped to lower priority queues.
d) Maximum utilization of the (outgoing) links should be achieved, i.e., DE=1 frames should be dropped only if there is no free capacity on the link. This is a practical efficiency requirement that prohibits solutions using e.g., policing of DE=1 packets within a traffic class according to some engineered bandwidth limits.

Frames with different DE bits arrive to a network node with a policer 401, the task of which is to filter out the DE=1 frames that need to be dropped due to resource problems at the outgoing switch interface. This is accomplished by a special token bucket 402. The token bucket 402 has a control mechanism that dictates when traffic can be transmitted, based on the presence of tokens 403 in the bucket. The token bucket 402 contains tokens 403, each of which can represent a unit of bytes. The network administrator specifies how many tokens 403 are needed to transmit. When tokens are present, a flow is allowed to transmit traffic. If there are no tokens in the bucket, a flow cannot transmit its packets. Therefore, a flow can transmit traffic up to its peak burst rate if there are adequate tokens in the bucket and if the burst threshold is configured appropriately.

Leaving the policer 401 frames are arranged to queues Q1, Q2, . . . Qn. Frames in a queue are usually arranged in first-in, first-out order, but various techniques may be used to prioritize packets or ensure that all packets are handled fairly, rather than allowing one source to grab more than its share of resources. Queue management is a part of packet classification and QoS schemes, in which flows are identified and classified, and then placed in queues that provide appropriate service levels.

The token rate C for this policer is equal to the link rate C. All DE=0 frames will be forwarded to one of the next queues Q1, Q2, . . . Qn, in case there is at least one token in the bucket. It should be noted that if some of DE=0 frame(s) have been transmitted without tokens then likely there will be drops of DE=0 frame(s) from the queues, on the basis of the traffic class/priority of frames. However, when either a DE=0 frame or a DE=1 frame is forwarded and there are tokens in the bucket, then the frame takes the corresponding number of tokens. This process therefore ensures that DE=1 frame can be forwarded only if the total rate of frames is lower than the outgoing link capacity C. By other words, it means that DE=1 frames are transmitted only if basically all transmitted frames can be served (because the incoming frame rate is lower than the link rate). At the output of the network node a scheduler 404 determines which frame to send next in order to manage and prioritize the allocation of bandwidth among the flows.

It is clearly seen that the policer 401 permits maximum utilization of the (outgoing) links, i.e., DE=1 frames are dropped only if there is no free capacity on a given link. So the performance of a network node is not degraded by inserting the policer 401.

It is important to note that the network node still inherits all advantages of the original multi-class queuing/scheduling functionality of IEEE 802.1ad switches. By dynamic queue management one achieves that DE=1 frames are dropped before any DE=0 frame is dropped in the same queue if the service rate of the given queue is smaller than the arriving frame rate to the given queue. By mapping DE=0 and DE=1 frames within the same class (and thus flow) to the same output queue after passing the node, frame reordering is not possible.

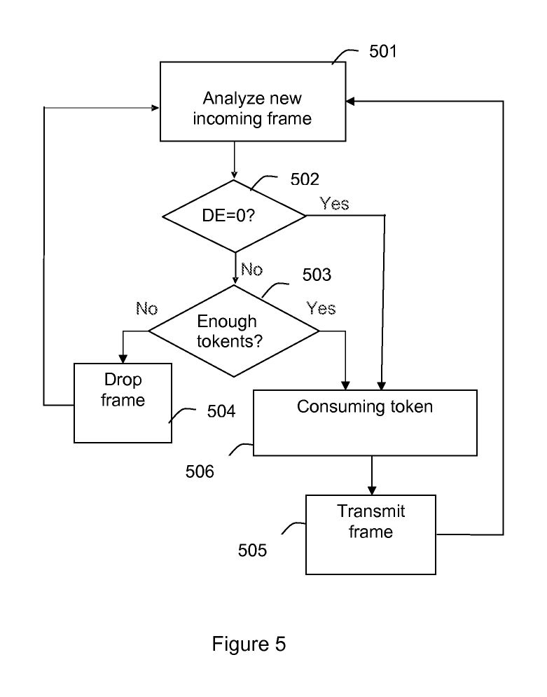

FIG. 5 shows the flowchart of the decision logic controlling the network node, and corresponds to the case when the DE=1 frames are handled with even less precedence then the ‘normal’ BE frames. If one wants to provide the same treatment for the DE=0 BE frames and other DE=1 frames, respectively, then the BE frame should be treated as DE=0 frames in the above process.

In the first step 501 the incoming frames are analyzed. Then a decision is made in step 502 if the frame has a DE=0 bit. If it has a DE=0 bit, then the tokens in the token bucket are consumed in step 506 and the frame is transmitted in step 505. If it is not a frame of DE=0 bit, then another decision step 503 is made to investigate if there is enough tokens in the bucket. If yes, then tokens in the token bucket are also consumed in step 506 and the frame is transmitted in step 505, if not, the frame is dropped.

There is however a theoretical possibility of causing preemption of DE=0 frames by DE=1 frames at output port with the above policer concept. If for example some DE=1 frames are arriving into the first level queue and if the ratio of the incoming frames makes it possible, they can be forwarded to the second level queues. Let's assume that in this situation a great burst of DE=0 frames are arriving into the first queue. Since all DE=0 frames need to be forwarded to the second level queues, it may happen that some of them will overflow. In this situation DE=0 frames will be dropped, although there are some DE=1 frames in the queues. However, we have to note that this situation is not a defect or limitation of the invention, but a generic problem: Without prediction of the ratio of incoming large bursts of DE=0 frames when some DE=1 frames are in the system, this situation may happen. The role of the token bucket size is to limit the maximum burst of DE=1 frames and thus to minimize the frequency of such events. The bucket size should be set based on the expected traffic burstiness as well as the length of output queues.

The obvious advantage of the method is that in general the DE=1 frames will be dropped before any DE=0 frame is dropped in any other traffic class (exception may be the BE frames). This complies with the MEF service specification and represents an enhancement compared to present art. The main gain is the enhancement of network performance in case of operator errors (e.g., improper provisioning or configuration errors) or network failures followed by traffic rerouting, which can cause traffic congestion. In such cases, the proposed function will minimize the impact on SLA violation.

It should be noted that the above feature of having relatively higher drop priority for the re-colored packets makes sense for other packet technologies as well that include the drop preference concept.

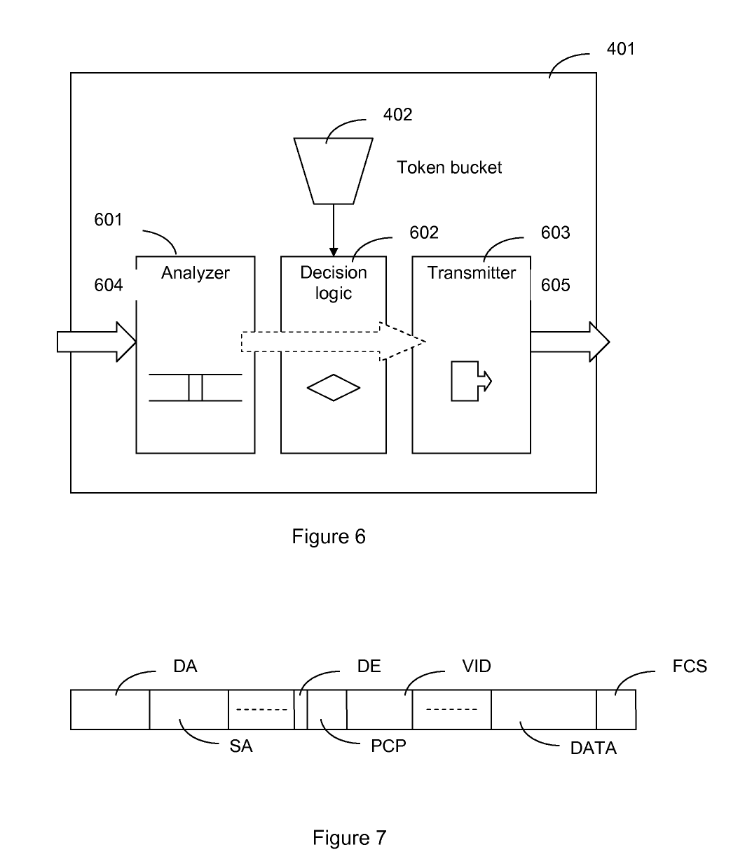

As it is seen in FIG. 6 in a preferred embodiment the policer 401 comprises an analyzer 601, which receives the incoming frames 604 and identifies the drop preference bits in the frame header. A decision logic 602 is applied to the analyzer 601 deciding whether the frame to be forwarded or to be dropped. Further on a transmitter 603 is also connected transmitting 605 or dropping the frames according to the decision of the decision logic 602.

If we want to distinguish the BE frames the decision logic will be slightly different.

FIG. 7 illustrates the relevant part of an Ethernet frame header according to IEEE 802.1ad indicating the DE bit and the bits of Priority Code Point PCP among the bits of Destination Address DA, Source Address SA, Virtual LAN ID VID, the Payload DATA and the Frame Check Sequence FCS. The three PCP bits can identify eight different classes ranging from 000 to 111. A set of 000 bits represent a BE frame.

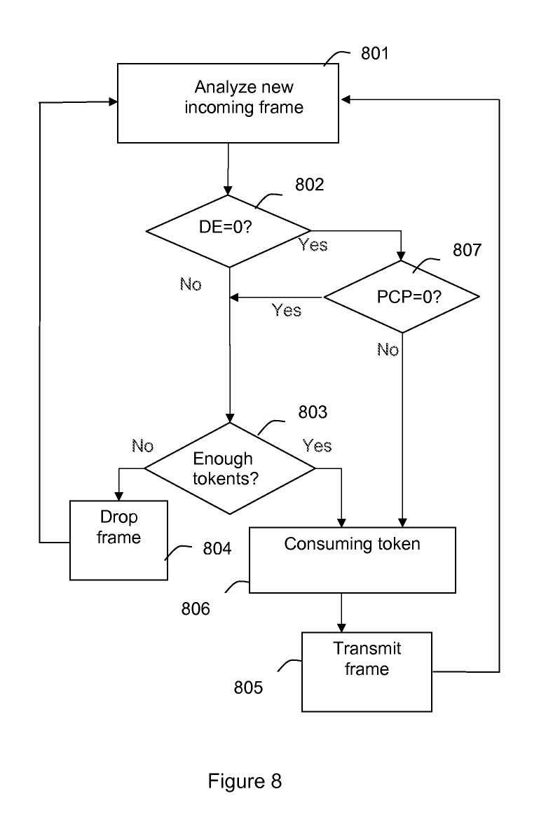

FIG. 8 shows the flowchart of the decision logic controlling the network node, and corresponds to the case when BE frame should be treated like DE=1 frames in the process.

In the first step 801 the incoming frames are analyzed. Then a decision is made in step 802 if the frame has a DE=0 bit. If it has a DE=0 bit, then another decision step 807 is made whether it is a BE frame. In BE frames PCP bits is 0. If it is not a BE frame, then the tokens in the token bucket are consumed in step 806 and the frame is transmitted in step 805. If it is a BE frame or the DECO (decision step 802), then another decision step 803 is made to investigate if there is enough tokens in the bucket. If yes, then tokens in the token bucket are also consumed in step 806 and the frame is transmitted in step 805, if not, the frame is dropped.

Another aspect of the invention is a computer program product, which can be stored in a computer readable medium, e.g. in a memory, in a hard disc or compact disc. Any of these media can store a program for causing a network node to control the traffic in a communications network according to the method described above.

Although a preferred embodiment of the present invention has been illustrated in the accompanying drawings and described in the foregoing detailed description, it is understood that the invention is not limited to the embodiment disclosed for Ethernet network, but is capable of numerous rearrangements, modifications, and substitutions for controlling traffic in a packet switched communications network without departing from the spirit of the invention based on a special policer function in the network node as realized and defined by the following claims.

1-12. (canceled)

13. A method for controlling traffic in a packet switched communications network comprising network nodes, in which network packets of flows can be distinguished by drop preference and can be put into queues according to traffic classes, said method comprising the steps of:
dropping packets with high drop preference in one traffic class before a packet of low drop preference is dropped in any other traffic class;
dropping packets with high drop preference before a packet of low drop preference is dropped in the same queue; and
preventing reordering of packets with low drop preference and packets with high drop preference within the same flow.

14. The method of claim 13, wherein the packets are dropped with high drop preference in one traffic class before packets with low drop preference are dropped in any other traffic class, except for Best Effort (BE) packets.

15. The method of claim 13, wherein the steps of dropping packets are controlled by a token bucket having a token rate which is indicative of link rate on an outgoing interface of the network node.

16. The method of claim 15, further comprising the steps of:
analyzing each incoming packet by the drop preference;
deciding if the packet is of low drop preference;
forwarding packets with low drop preference onto output queues and consuming a token from the token bucket if available;
forwarding packets with high drop preference onto the output queues if there is an available token in the token bucket, and consuming the token from the token bucket if available; and
dropping packets with high drop preference if there is no available token in the token bucket.

17. The method of claim 16, wherein the method further comprises the steps of:
deciding whether the packet is a Best Effort (BE) packet;
processing the packet with high drop preference if the packet is a Best Effort (BE) packet; and
processing the packet with low drop preference if the packet is not a Best Effort (BE) packet.

18. The method of claim 13, wherein the packet switched communications network is an Ethernet network in which traffic is forwarded by flow of frames, and the dropping preference is represented by a drop eligible (DE) bit in an Ethernet frame.

19. A network node in a packet switched communications network capable of distinguishing packets by drop preference, said network node comprising a policer including:
an analyzer for receiving incoming packets and identifying the drop preference bits in a packet header;
decision logic for deciding whether the packet is to be forwarded or dropped; and
a transmitter receiving packets from the analyzer and transmitting or dropping the packets according to the decision of the decision logic.

20. The network node of claim 19, wherein the policer further includes a token bucket control, wherein token rate is indicative of link rate of an outgoing interface of the network node.

21. The network node of claim 20, wherein the rate of a token bucket is equal to or less than the link rate of the outgoing interface of the network node.

22. A packet switched communications network comprising network nodes connected to each other, in which network packets can be distinguished by drop preference and can be put to queues according to traffic classes, wherein at least part of the network nodes comprise a policer configured to:
drop packets with high drop preference in one traffic class before a packet of low drop preference is dropped in any other traffic class;
drop packets with high drop preference before a packet of low drop preference is dropped in the same queue;
prevent the reordering of network packets with low drop preference and packets with high drop preference within a same flow.

23. The packet switched communication network of claim 22, wherein the packet switched communications network is implemented as an Ethernet network, wherein traffic is forwarded by flow of frames, and the dropping preferences are represented by Drop Eligible (DE) bits.
